(19) United States
(12) Patent Application Publication
(10) Pub. No.: US 2025/0224625 A1
(43) Pub. Date: Jul. 10, 2025

(54) EXTENDED REALITY DISPLAY SYSTEM WITH VISION CORRECTION

(71) Applicant: Magic Leap, Inc., Plantation, FL (US)

(72) Inventors: Evan Francis RYNK, Boca Raton, FL (US); Bach NGUYEN, Coral Springs, FL (US); Jason Paul HALE, Pembroke Pines, FL (US); Christian MELO, Miami, FL (US); Donald W. BURNETTE, Plantation, FL (US); Masamune KAJI, Coral Springs, FL (US); Shigeru NATSUME, Weston, FL (US); Haney AWAD, Miami, FL (US); Shirly TAM, Lauderdale Lakes, FL (US)

(73) Assignee: Magic Leap, Inc., Plantation, FL (US)

(21) Appl. No.: 18/843,628

(22) PCT Filed: Mar. 3, 2023
(86) PCT No.: PCT/US2023/063675

§ 371 Date: Sep. 3, 2024

Related U.S. Application Data
(60) Provisional application No. 63/316,684, filed on Mar. 4, 2022.

(51) Int. Cl. G02C 7/08; G02B 27/01; G02C 3/00

(52) U.S. Cl. CPC G02C 7/086; G02B 27/0176; G02B 27/0179; G02C 3/003; G02B 2027/0154; G02B 2027/0178; G02B 2027/0187

(57) ABSTRACT

An extended reality (XR) system includes an XR display configured to be movably disposed in a line of sight of a user. The system also includes a vision correction component configured to be disposed in the line of sight of the user. The system further includes a displacement mechanism configured to guide the XR display out of the line of sight of the user while the vision correction component remains in the line of sight of the user, and limit relative positions of the XR display and the vision correction component.

### INCORPORATION BY REFERENCE

This application claims priority to U.S. Provisional Patent Application Ser. No. 63/316,684, filed on Mar. 4, 2022, the contents of which are hereby expressly and fully incorporated by reference in its entirety. This application also incorporates by reference the entirety of each of the following patent applications: U.S. patent application Ser. No. 14/205,126, filed on Mar. 11, 2014; U.S. patent application Ser. No. 14/212,961, filed on Mar. 14, 2014; U.S. patent application Ser. No. 14/331,218, filed on Jul. 14, 2014; U.S. patent application Ser. No. 14/555,585, filed on Nov. 27, 2014; U.S. patent application Ser. No. 14/690,401, filed on Apr. 18, 2015; U.S. patent application Ser. No. 14/738,877, filed on Jun. 13, 2015; and U.S. patent application Ser. No. 16/215,477, filed on Dec. 10, 2018.

### FIELD OF THE INVENTION

The present disclosure relates to extended reality (i.e., virtual reality, augmented reality, and/or mixed reality) display systems. In particular, the present disclosure relates to extended reality display systems with vision correction elements.

### BACKGROUND

Modern computing and display technologies have facilitated the development of “extended reality” (XR) systems for so called “virtual reality” (VR), “augmented reality” (AR), or “mixed reality” (MR) experiences, wherein digitally reproduced images or portions thereof are presented to a user in a manner wherein they seem to be, or may be perceived as, real. A VR scenario typically involves presentation of digital or virtual image information without transparency to actual real-world visual input. An AR scenario typically involves presentation of digital or virtual image information as an augmentation to visualization of the real world around the user (i.e., transparency to real-world visual input). A MR scenario typically involves presentation of digital or virtual objects that interact with real world objects. Accordingly, AR and MR scenarios involve presentation of digital or virtual image information with transparency to the real-world visual input.

Various optical systems generate images, including color images, at various depths for displaying XR (VR, AR, and MR) scenarios. Some such optical systems are described in U.S. Utility patent application Ser. No. 14/555,585 filed on Nov. 27, 2014, the contents of which have been previously incorporated by reference herein.

XR systems typically employ wearable display devices (e.g., head-worn displays, helmet-mounted displays, or smart glasses) that are coupled to a user's head. Head-worn display devices that enable AR and MR provide concurrent viewing of both real and virtual objects. With an “optical see-through” display, a user can see through transparent (or semi-transparent) elements in a display system to view directly the light from real objects in an environment. The transparent element, often referred to as a “combiner,” superimposes light from the display over the user's view of the real world, where light from by the display projects an image of virtual content over the see-through view of the real objects in the environment. A camera may be mounted onto the head-worn display device to capture images or videos of the scene being viewed by the user.

Current optical systems, such as those in XR systems, optically render virtual content. Content is “virtual” in that if does not correspond to real physical objects located in respective positions in space. Instead, virtual content only exists in the brains (e.g., the optical centers) of a user of the head-worn display device when stimulated by light beams directed to the eyes of the user. XR systems attempt to present color, photo-realistic, immersive XR scenarios.

Vision correction components, such as prescription (Rx) lenses can be incorporated into wearable XR display devices. However, the compact size and lightweight design of wearable XR display devices make it difficult to remove the wearable XR display devices while retaining the vision correction components in a line of sight of a user. Even if a wearable XR display device could be removed while retaining the vision correction component, when the wearable XR display device is returned to the line of sight of the user, misalignment of the wearable XR display device and the vision correction component can reduce the quality of the XR scenario. Further, in wearable XR display devices with eye-tracking cameras, such eye-tracking cameras must also be aligned with any vision correction components in such wearable XR display devices.

A user may want to temporarily remove a wearable XR display device from the line of sight of the user because such devices can reduce light from the environment by as much as 80% and also reduce the field of view of the user. Wearable XR display devices that can be temporarily removed while retaining vision correction for users to attain a vision corrected unobstructed view are needed. Such devices facilitate performance of critical tasks (e.g., surgeries and other medical procedures) requiring accuracy and precision by users in need of vision correction. During the performance of such critical tasks, disruption of vision correction may create unsafe situations. The systems and methods described herein are configured to address these challenges.

### SUMMARY

Embodiments are directed to wearable XR display devices, which can be removed while retaining vision correction for users.

In one embodiment, an extended reality (XR) system includes an XR display configured to be movably disposed in a line of sight of a user. The system also includes a vision correction component configured to be disposed in the line of sight of the user. The system further includes a displacement mechanism configured to guide the XR display out of the line of sight of the user while the vision correction component remains in the line of sight of the user, and limit relative positions of the XR display and the vision correction component.

In one or more embodiments, the vision correction component includes a lens. The displacement mechanism may include a hinge coupled to the XR display and configured to rotate the XR display out of the line of sight of the user. The hinge may be spring-loaded. The hinge may include a release pin. The hinge may include a cam-spring actuated rotating mechanism or a sliding-spring actuated rotating mechanism. The displacement mechanism may also be a registration mechanism.

In one or more embodiments, the hinge includes a gear-driven rotating mechanism. The gear-driven rotating mechanism may include a frictional rotation mechanism. The system may also include a sliding mechanism configured to translate the XR display relative to the vision correction component. The system may also include further including a locking knob configured to prevent the XR display from translating relative to the vision correction component. The gear-driven rotating mechanism may include fluid rotation mechanism.

In one or more embodiments, the system includes a head-mounted member coupled to the head of the user. The XR display is movably coupled to the head-mounted member by the hinge. The vision correction component is removably coupled to the head-mounted member. The system may also include a frame including a pair of hooks configured to couple the frame to the head of the user, wherein the vision correction component is disposed in the frame.

In one or more embodiments, the displacement mechanism includes a stationary member coupled to the user's head and defining a groove therein, and a pin coupled to the XR display and configured to travel in the groove in the stationary member to move the XR display coupled thereto out of the line of sight of the user. The displacement mechanism also includes a hinge including the pin and configured to rotate the XR display out of the line of sight of the user.

In one or more embodiments, the system also includes a pair of goggles, the vision correction component is disposed in the pair of goggles, and the XR display is coupled to the pair of goggles. The displacement mechanism may include a hinge configured to rotate the XR display out of the line of sight of the user. A side of the pair of goggles may be substantially transparent.

In one or more embodiments, the system also includes an eye-tracking system coupled to the vision correction component. The XR system may be configured such that when the XR display is moved out of the light of sight of the user, the eye-tracking system remains coupled to the vision correction component. The XR system may be configured such that when the XR display is moved out of the light of sight of the user, the eye-tracking system and the vision correction component remain in the line of sight of the user. The eye-tracking component may include a sensor. The sensor may be a camera. The eye-tracking component may also include an inward facing light source.

In another embodiment, an extended reality (XR) system includes an XR display configured to be movably disposed in a line of sight of a user, the XR display having a first vision correction component. The XR system also includes a second vision correction component configured to be movably disposed in the line of sight of the user when the XR display is not disposed in the line of sight of the user. The XR system further includes a mechanical linkage configured to move the second vision correction component into the line of sight of the user when the XR display is moved out of the line of sight of the user, and move the second vision correction component out of the line of sight of the user when the XR display is moved into the line of sight of the user.

In one or more embodiments, the first vision correction component includes a first lens coupled to the XR display. The first lens may be magnetically coupled to the XR display. The second vision correction component may include a second lens. The mechanical linkage may include a gearing system. The XR display may be configured to move up and down relative to the user's head.

In one or more embodiments, the second vision correction component is configured to move up and down relative to the user's head. The mechanical linkage may be configured to move the second vision correction component down into the line of sight of the user when the XR display is moved up out of the line of sight of the user. The mechanical linkage may be configured to move the second vision correction component up out of the line of sight of the user when the XR display is moved down into the line of sight of the user.

In one or more embodiments, the system also includes an eye-tracking system coupled to the vision correction component. The XR system may be configured such that when the XR display is moved out of the light of sight of the user, the eye-tracking system remains coupled to the vision correction component. The XR system may be configured such that when the XR display is moved out of the light of sight of the user, the eye-tracking system and the vision correction component remain in the line of sight of the user. The eye-tracking component may include a sensor. The sensor may be a camera. The eye-tracking component may also include an inward facing light source.

Additional and other objects, features, and advantages of the disclosure are described in the detail description, figures and claims.

### BRIEF DESCRIPTION OF THE DRAWINGS

This patent or application file contains at least one drawing executed in color. Copies of this patent or patent application publication with color drawings will be provided by the U.S. Patent and Trademark Office upon request and payment of the necessary fee.

The foregoing and other aspects of embodiments are described in further detail with reference to the accompanying drawings, in which the same elements in different figures are referred to by common reference numerals, wherein:

FIG. 1 depicts a user's view of AR/MR through a wearable AR/MR user device, according to some embodiments.

FIG. 2 schematically depicts XR systems and subsystems thereof, according to some embodiments.

FIG. 3 is a perspective view depicting components of an XR system, according to some embodiments.

FIGS. 4A to 4C are perspective views depicting components of an XR system, according to some embodiments.

FIGS. 5A and 5B are perspective views depicting components of an XR system in two configurations, according to some embodiments.

FIGS. 6A to 6D are perspective, top, front, and side views depicting components of an XR system, according to some embodiments.

FIGS. 7A to 7C are perspective, side, and front views depicting components of an XR system, according to some embodiments.

FIGS. 8A to 8D are perspective, front, side, and front views depicting components of an XR system in two configurations on a user's head, according to some embodiments.

FIGS. 9A to 9D are perspective views depicting components of an XR system in various states of assembly, according to some embodiments.

FIG. 10 is a side view depicting components of an XR system in two configurations on a user's head, according to some embodiments.

FIGS. 11A to 11C are perspective, exploded, and perspective views depicting components of an XR system, according to some embodiments.

FIGS. 11D and 11E are exploded and side cross-sectional views depicting a hinge mechanism for an XR system, according to some embodiments.

FIG. 12 is an exploded view depicting a hinge mechanism for an XR system, according to some embodiments.

FIGS. 13A and 13B are perspective and back views depicting components of an XR system, according to some embodiments.

FIGS. 14A and 14B are perspective and side views depicting components of an XR system on a user's head, according to some embodiments.

FIGS. 15A to 15D are side, front, top, and perspective views depicting components of an XR system on a user's head, according to some embodiments.

FIG. 15E is an exploded view depicting components of an XR display for use with an XR system, according to some embodiments.

FIGS. 16A to 16D are front and side views depicting components of an XR system on a user's head, according to some embodiments.

FIGS. 17A to 17C are perspective, exploded, and side views depicting components of an XR system including an eye-tracking module, according to some embodiments.

FIGS. 18A and 18B are perspective views depicting components of an XR system in two different configurations on a user's head, according to some embodiments.

FIGS. 19A and 19B schematically depict components of an XR system in two different configurations, according to some embodiments.

In order to better appreciate how to obtain the above-recited and other advantages and objects of various embodiments, a more detailed description of embodiments is provided with reference to the accompanying drawings. It should be noted that the drawings are not drawn to scale and that elements of similar structures or functions are represented by like reference numerals throughout. It will be understood that these drawings depict only certain illustrated embodiments and are not therefore to be considered limiting of scope of embodiments.

### DETAILED DESCRIPTION OF ILLUSTRATED EMBODIMENTS

Various embodiments of the disclosure are directed to systems, methods, and articles of manufacture for controlling the performance of XR systems in a single embodiment or in multiple embodiments. Other objects, features, and advantages of the disclosure are described in the detailed description, figures, and claims.

Various embodiments will now be described in detail with reference to the drawings, which are provided as illustrative examples of the disclosure so as to enable those skilled in the art to practice the disclosure. Notably, the figures and the examples below are not meant to limit the scope of the present disclosure. Where certain elements of the present disclosure may be partially or fully implemented using known components (or methods or processes), only those portions of such known components (or methods or processes) that are necessary for an understanding of the present disclosure will be described, and the detailed descriptions of other portions of such known components (or methods or processes) will be omitted so as not to obscure the disclosure. Further, various embodiments encompass present and future known equivalents to the components referred to herein by way of illustration.

The performance control systems may be implemented independently of XR systems, but some embodiments below are described in relation to AR systems for illustrative purposes only. For instance, the performance control systems described herein may also be used in an identical manner with VR and MR systems.

### Illustrative AR Scenario and System

The description that follows pertains to an illustrative AR system the performance of which may be controlled/modified. However, it is to be understood that the embodiments also lend themselves to applications in other types of display systems (including other types of XR systems such as VR and MR systems), and therefore the embodiments are not to be limited to only the illustrative system disclosed herein.

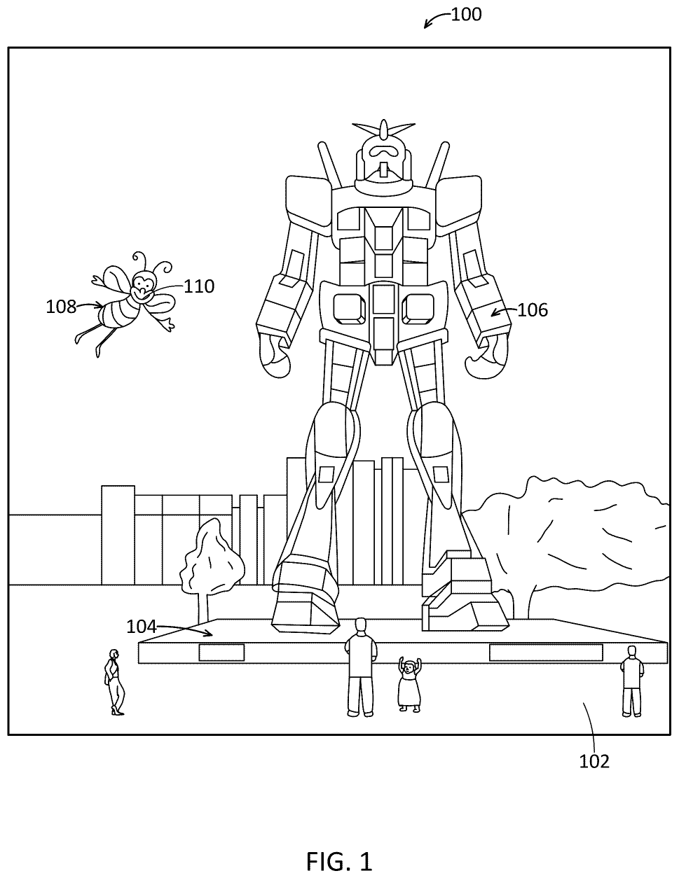

AR scenarios often include presentation of virtual content (e.g., color images and sound) corresponding to virtual objects in relationship to real-world objects. For example, referring to FIG. 1, an AR scene 100 is depicted wherein a user of an AR technology sees a real-world, physical, park-like setting 102 featuring people, trees, buildings in the background, and a real-world, physical concrete platform 104. In addition to these items, users of the AR technology also perceive that they “see” a virtual robot statue 106 standing upon the physical concrete platform 104, and a virtual cartoon-like avatar character 108 flying by which seems to be a personification of a bumblebee, even though these virtual objects 106, 108 do not exist in the real-world.

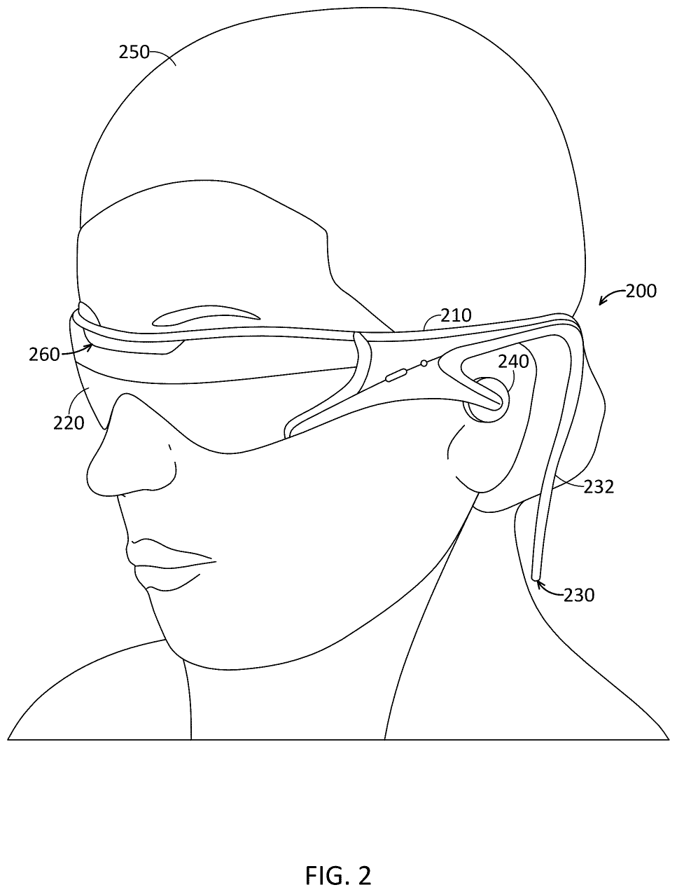

FIG. 2 depicts an AR system 200 according to some embodiments. The AR system 200 may be operated in conjunction with a control subsystem 230, providing images of virtual objects intermixed with physical objects in a field of view of a user 250. This approach employs one or more at least partially transparent surfaces through which an ambient real-world environment including the physical objects can be seen and through which the AR system 200 produces images of the virtual objects. The control subsystem 230 is operatively coupled to a display system 220 through a link 232. The link 232 may be a wired or wireless communication link.

For AR applications, it may be desirable to spatially position various virtual objects relative to respective physical objects in a field of view of the user 250. The virtual objects may take any of a large variety of forms, having any variety of data, information, concept, or logical construct capable of being represented as an image. Non-limiting examples of virtual objects may include: a virtual text object, a virtual numeric object, a virtual alphanumeric object, a virtual tag object, a virtual field object, a virtual chart object, a virtual map object, a virtual instrumentation object, or a virtual visual representation of a physical object.

The AR system 200 comprises a frame structure 210 worn by the user 250, the display system 220 carried by the frame structure 210, such that the display system 220 is positioned in front of the eyes of the user 250 and in a line of sight of the user 250, and a speaker 240 incorporated into or connected to the display system 220. In the illustrated embodiment, the speaker 240 is carried by the frame structure 210, such that the speaker 240 is positioned adjacent (in or around) the ear canal of the user 250, e.g., an earbud or headphone.

The display system 220 is designed to present the eyes of the user 250 with photo-based radiation patterns that can be comfortably perceived as augmentations to the ambient environment including both two-dimensional and 3D content. The display system 220 presents a sequence of frames at high frequency that provides the perception of a single coherent scene. To this end, the display system 220 includes a partially transparent display screen through which the images are projected to the eyes of the user 250. The display screen is positioned in a field of view of the user 250 between the eyes of the user 250 and the ambient environment.

In some embodiments, the display system 220 generates a series of synthetic image frames of pixel information that present an undistorted image of one or more virtual objects to the user. The display system 220 may also generate a series of color synthetic sub-image frames of pixel information that present an undistorted color image of one or more virtual objects to the user. Further details describing display subsystems are provided in U.S. patent application Ser. Nos. 14/212,961 and 14/331,218, the contents of which have been previously incorporated by reference herein.

The AR system 200 further includes one or more sensors mounted to the frame structure 210 for detecting the position (including orientation) and movement of the head of the user 250. Such sensor(s) may include image capture devices, microphones, inertial measurement units (IMUs), accelerometers, compasses, GPS units, radio devices, gyros and the like. For example, in one embodiment, the AR system 200 includes a head worn transducer subsystem that includes one or more inertial transducers to capture inertial measures indicative of movement of the head of the user 250. Such devices may be used to sense, measure, or collect information about the head movements of the user 250. For instance, these devices may be used to detect/measure movements, speeds, acceleration and/or positions of the head of the user 250. The position (including orientation) of the head of the user 250 is also known as a “head pose” of the user 250.

The AR system 200 of FIG. 2 may include one or more forward facing cameras. The cameras may be employed for any number of purposes, such as recording of images/video from the forward direction of the system 200. In addition, the cameras may be used to capture information about the environment in which the user 250 is located, such as information indicative of distance, orientation, and/or angular position of the user 250 with respect to that environment and specific objects in that environment.

The AR system 200 may further include rearward facing cameras to track angular position (the direction in which the eye or eyes are pointing), blinking, and depth of focus (by detecting eye convergence) of the eyes of the user 250. Such eye tracking information may, for example, be discerned by projecting light at the end user's eyes, and detecting the return or reflection of at least some of that projected light. The rearward facing cameras may form part of an eye tracking module 260. The eye tracking module 260 tracks the eyes of the user 250, and in particular the direction and/or distance at which the user 250 is focused based on the tracking data received from the rearward facing cameras.

The control subsystem 230 that may take any of a large variety of forms. The control subsystem 230 includes a number of controllers, for instance one or more microcontrollers, microprocessors or central processing units (CPUs), digital signal processors, graphics processing units (GPUs), other integrated circuit controllers, such as application specific integrated circuits (ASICs), programmable gate arrays (PGAs), for instance field PGAs (FPGAs), and/or programmable logic controllers (PLUS). The control subsystem 230 may include a digital signal processor (DSP), a central processing unit (CPU), a graphics processing unit (GPU), and one or more frame buffers. The CPU controls overall operation of the system, while the GPU renders frames (i.e., translating a 3D scene into a two-dimensional image) and stores these frames in the frame buffer(s). One or more additional integrated circuits may control the reading into and/or reading out of frames from the frame buffer(s) and operation of the display system 220. Reading into and/or out of the frame buffer(s) may employ dynamic addressing, for instance, where frames are over-rendered. The control subsystem 230 further includes a read only memory (ROM) and a random-access memory (RAM). The control subsystem 230 further includes a 3D database from which the GPU can access 3D data of one or more scenes for rendering frames, as well as synthetic sound data associated with virtual sound sources contained within the 3D scenes.

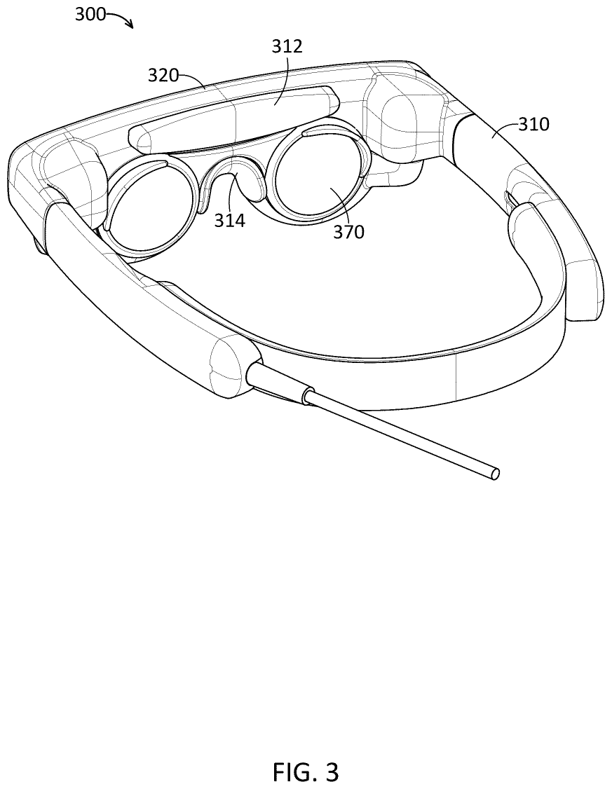

FIG. 3 is a rear perspective view depicting components of an XR system 300 according to some embodiments. The XR system 300 includes a wearable XR display device 320. The XR system 300 also includes a frame 310 configured to hold the display device 320 on a user's head such that the display device 320 is disposed in a line of sight of the user. The frame 310 includes a forehead pad 312 and a nosepiece 314 configured to comfortably support the weight of the display device 320 on the user's head. The XR system 300 also includes a vision correction component 370, which may be prescription (Rx) lenses 370. The vision correction component 370 may be magnetically coupled to the frame 310 to place the vision correction component 370 in the line of sight of the user wearing the display device 320. The XR system 300 embodiments described herein decouple the display device 320 from the vision correction component 370 such that the display device 320 can be temporarily removed from the line of sight of the user while the vision correction component 370 maintains uninterrupted vision correction for the user. The embodiments also maintain registration between the display device 320 and the vision correction component 370 such that the relative positions of the display device 320 and the vision correction component 370 are preserved when the display device 320 is returned to the line of sight of the user.

### Exemplary XR Systems

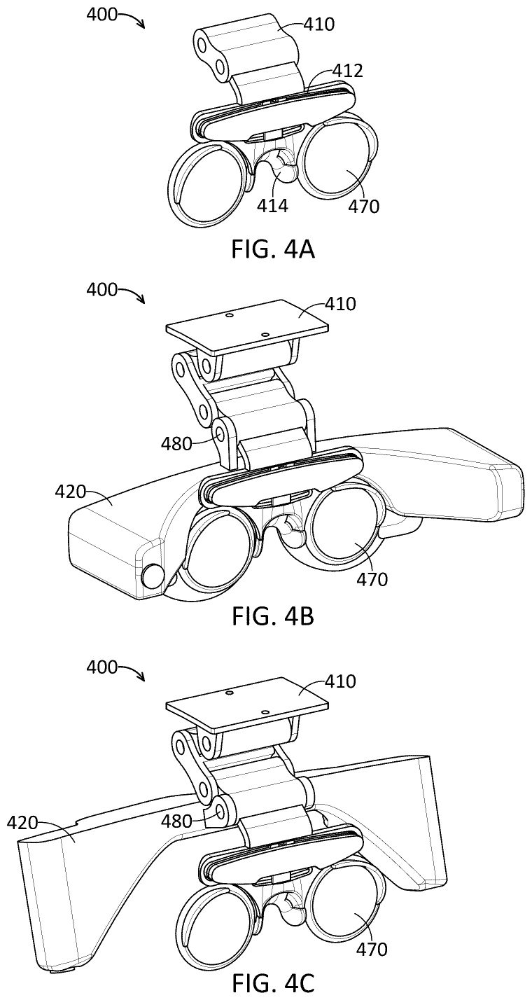

FIGS. 4A to 4C are rear perspective views depicting components of an XR system 400 according to some embodiments. FIG. 4A shows a vision correction component 470 (e.g., Rx lenses) coupled to a portion of a frame 410 of the XR system 400, which includes forehead pad 412 and nosepiece 414. The portion of the frame 410 is coupled the remainder of the frame which is removably coupled to a user's head (e.g., with a headband or arms). FIGS. 4B and 4C show an XR display 420, which is rotatably coupled to the portion of the frame 410 by displacement mechanism in the form of a hinge 480.

The hinge 480 allows the XR display 420 to be rotated into (FIG. 4B) and out of (FIG. 4C) a line of sight of a user wearing the XR display 420 of the XR system 400. As such, the displacement mechanism/hinge 480 allows the XR display 420 to be rotated outside of the line of sight of the user (FIG. 4B) while the vision correction component 470 remains in the user's line of sight for uninterrupted vision correction. The hinge 480 may have a built-in stop (e.g., an internal stop) that functions as a registration mechanism to assure that the relative positions of the XR display 420 and the vision correction component 470 are preserved when the XR display 420 is returned to the line of sight of the user (FIG. 4C).

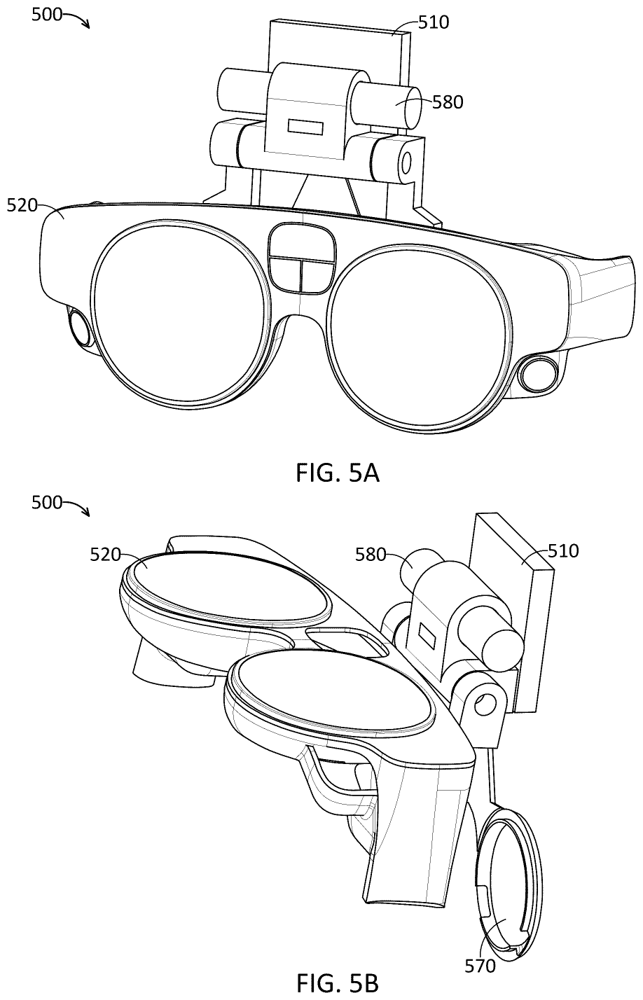

FIGS. 5A and 5B are front and side perspective views depicting components of an XR system 500 in two configurations, according to some embodiments. The XR system 500 includes a frame 510 (a portion of which is shown), an XR display 520 coupled to the frame 510 by a hinge 580, and a vision correction component 570 coupled to the frame 510. The difference between the XR systems 400, 500 is that the hinge 580 in FIGS. 5A and 5B is spring-loaded such that actuating the hinge 580 rotates the XR display 520 upward and out of the line of sight of the user. FIG. 5A depicts an augmented configuration in which the XR display 520 is disposed in the user's line of sight. FIG. 5B depicts a clear configuration in which the XR display 520 is rotated up outside of the user's line of sight. The transition from the augmented configuration to the clear configuration automatically completes once the hinge 580 is actuated. In various embodiments, the hinge 580 may be actuated by moving a release pin (not shown) and/or rotating the XR display 520 upward through a predetermined small angle.

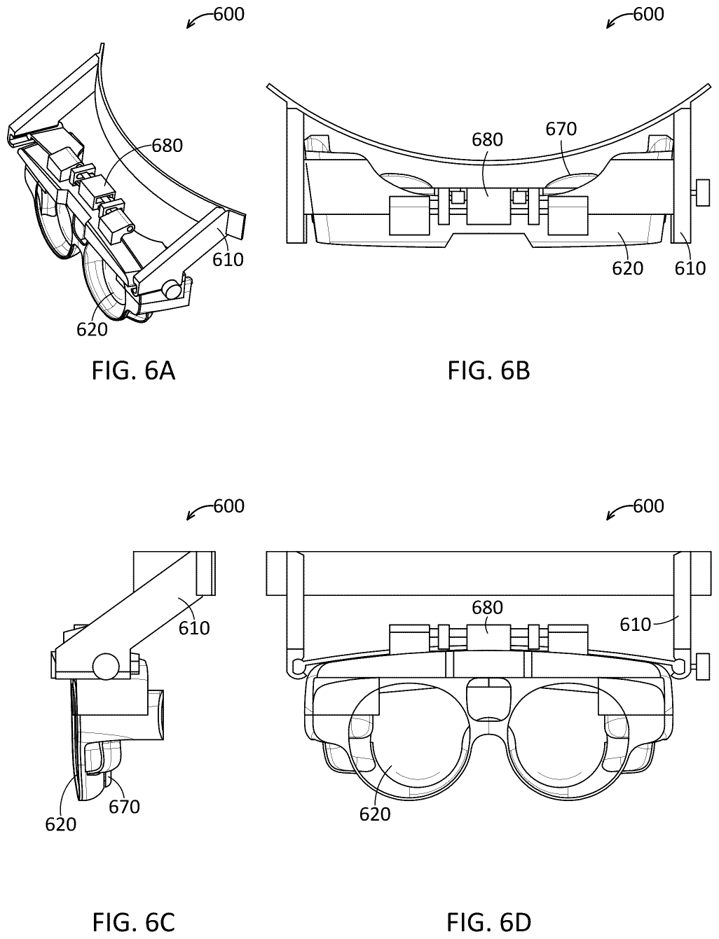

FIGS. 6A to 6D are perspective, top, front, and side views depicting components of an XR system 600, according to some embodiments. The XR system 600 includes a frame 610 (a portion of which is shown), an XR display 620 coupled to the frame 610 by a hinge 680, and a vision correction component 670 coupled to the frame 610. The hinge 680 is spring-loaded by a cam-spring.

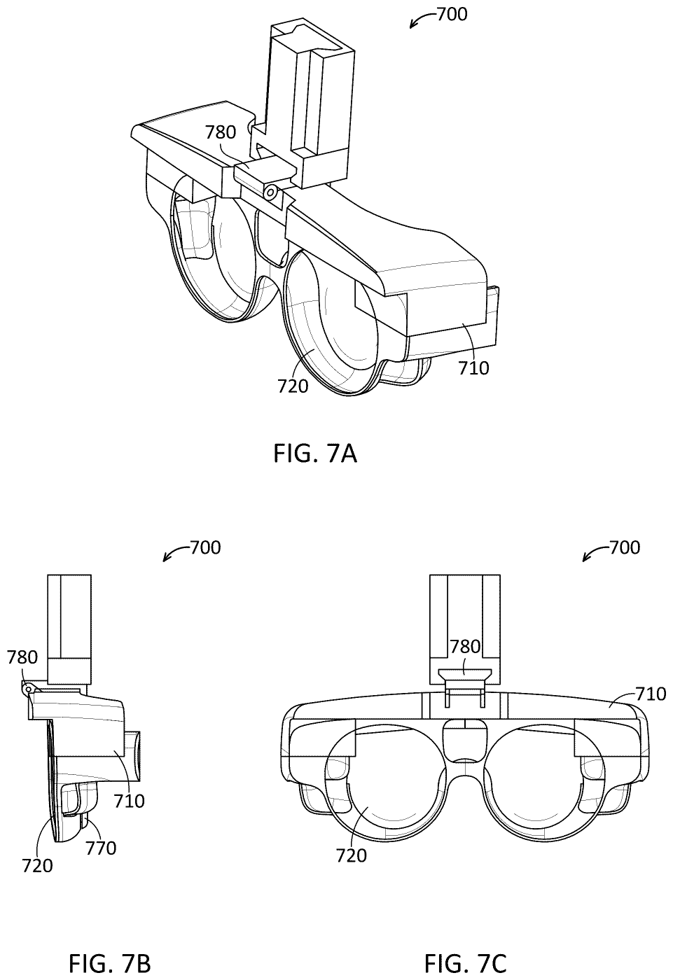

FIGS. 7A to 7C are perspective, side, and front views depicting components of an XR system 600, according to some embodiments. The XR system 700 includes a frame 710 (a portion of which is shown), an XR display 720 coupled to the frame 710 by a hinge 780, and a vision correction component 770 coupled to the frame 710. The hinge 780 is spring-loaded by a sliding-spring.

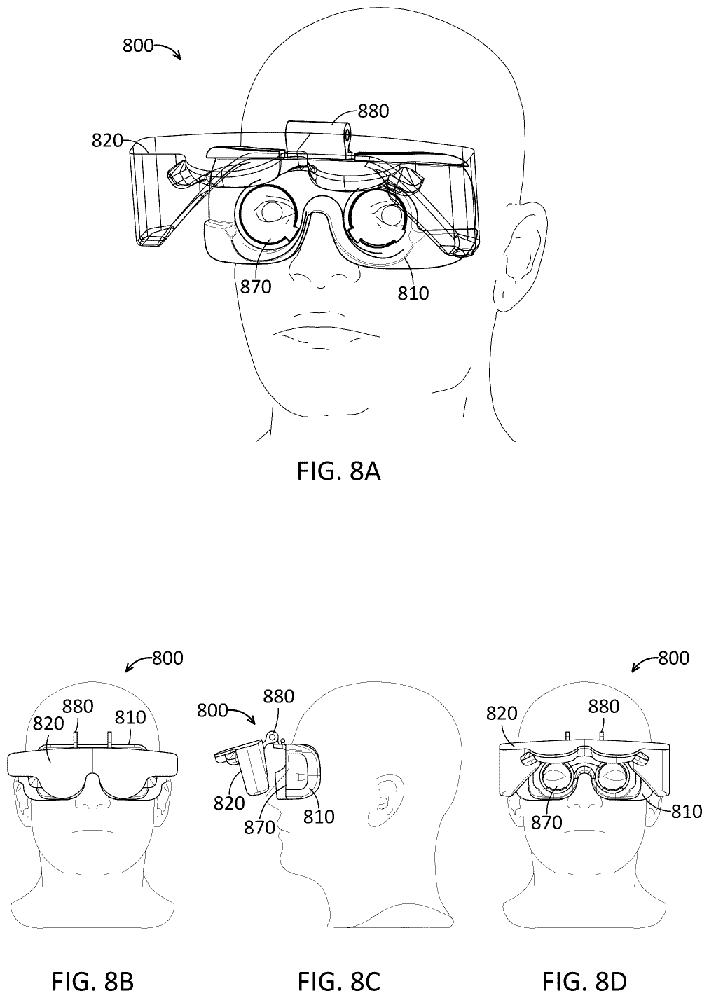

FIGS. 8A to 8D are perspective, front, side, and front views depicting components of an XR system 800 in two configurations on a user's head, according to some embodiments. The XR system 800 includes a frame 810 (a portion of which is shown), an XR display 820 coupled to the frame 810 by a hinge 880, and a vision correction component 870 coupled to the frame 810. The difference between the XR systems 500, 800 is that the frame 810 in FIGS. 8A and 8B is a pair of goggles configured to hold the XR system 800 onto a user's head. The top, sides, and bottom of the pair of goggles may be substantially transparent to increase the field of view of the user.

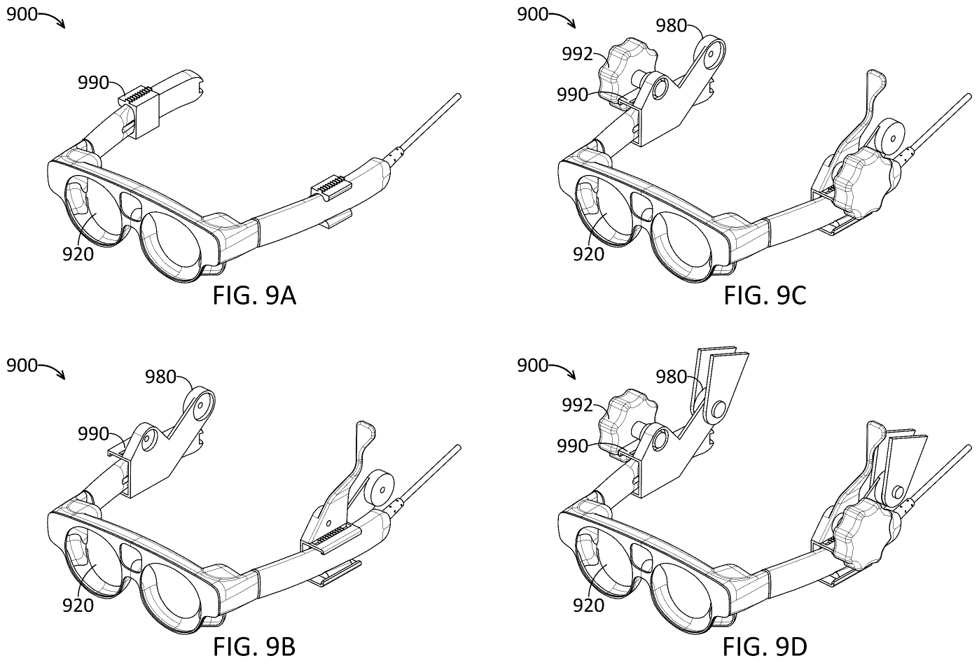

FIGS. 9A to 9D are perspective views depicting components of an XR system 900 in various states of assembly, according to some embodiments. The XR system 900 includes a frame (not shown and an XR display 920 coupled to the frame by a hinge 980. A vision correction component (not shown) can be coupled to the frame. The difference between the XR systems 500, 900 is that the hinge 980 is gear driven. Further, the XR system 900 includes a sliding mechanism 990 configured to translate the XR display 920 relative to the vision correction component. The sliding mechanism 990 also includes a locking knob 992 configured to prevent the XR display 920 from translating relative to the vision correction component. The sliding mechanism 990 adds another degree of freedom of movement of the XR display 920 relative to the vision correction component.

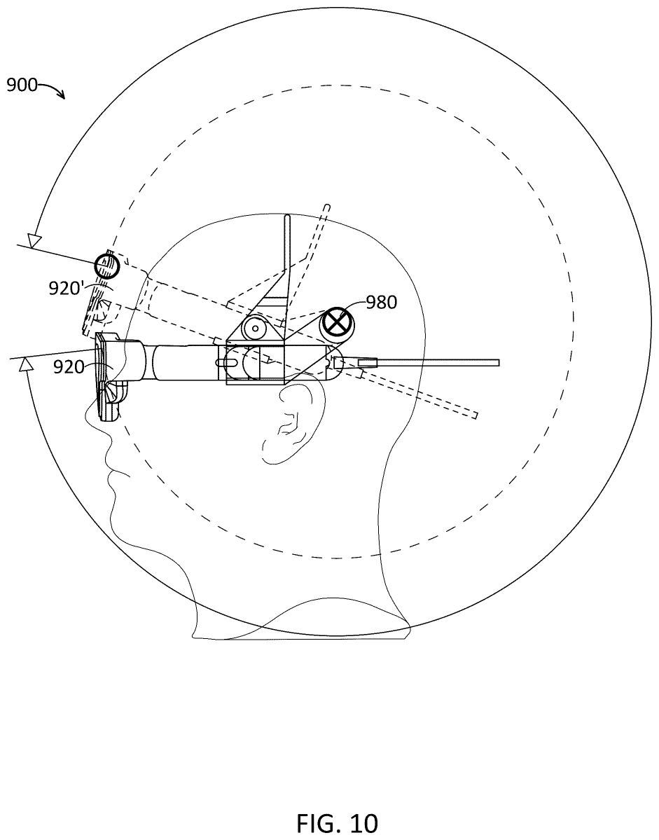

FIG. 10 is a side view depicting components of the XR system 900 depicted in FIGS. 9A to 9D in two configurations on a user's head, according to some embodiments. The XR system 900 includes a frame (not shown and an XR display 920 coupled to the frame by a hinge 980. A vision correction component (not shown) can be coupled to the frame. The XR system 900 can be in an augmented configuration in which the XR display 920 is disposed in the line of sight of the user or a clear configuration in which the XR display 920′ as been rotated and optionally translated out of the user's line of sight.

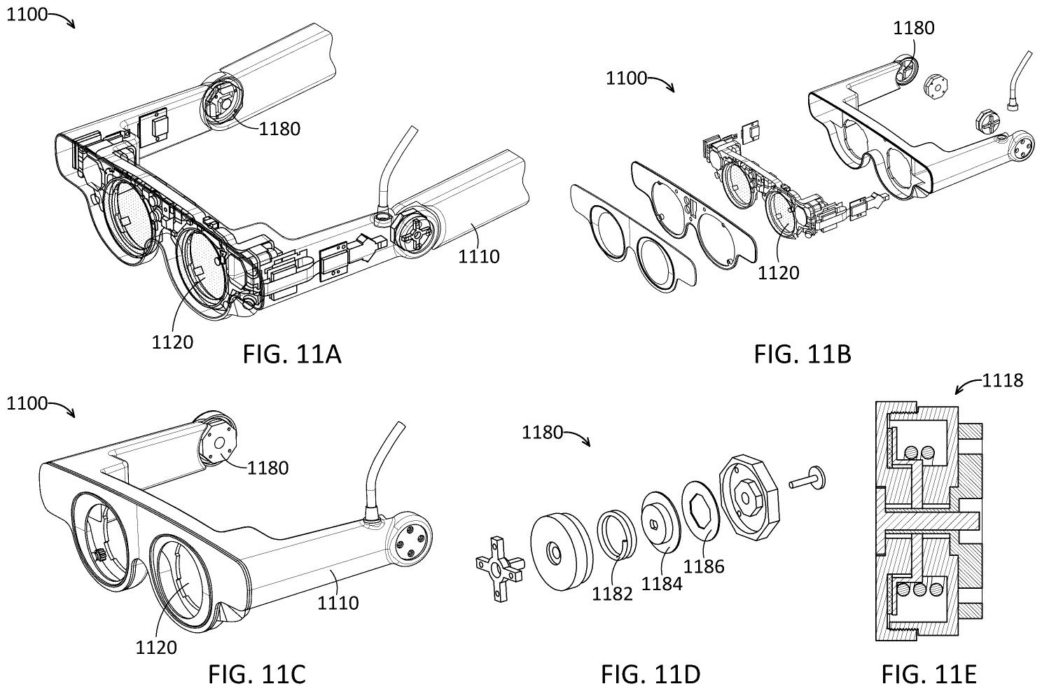

FIGS. 11A to 11C are perspective, exploded, and perspective views depicting components of an XR system 1100, according to some embodiments. The XR system 1100 includes a frame 1110 (a portion of which is shown) and an XR display 1120 coupled to the frame 1110 by a hinge 1180. A vision correction component (not shown) can be coupled to the frame 1110.

FIGS. 11D and 11E are exploded and side cross-sectional views depicting a hinge mechanism 1180 for use with the XR system 1100 depicted in FIGS. 11A to 11C, according to some embodiments. The hinge mechanism 1180 depicted in FIG. 11D is a friction mechanism with a spring 1182, a pressure plate 1184, and a Delrin plate 1186.

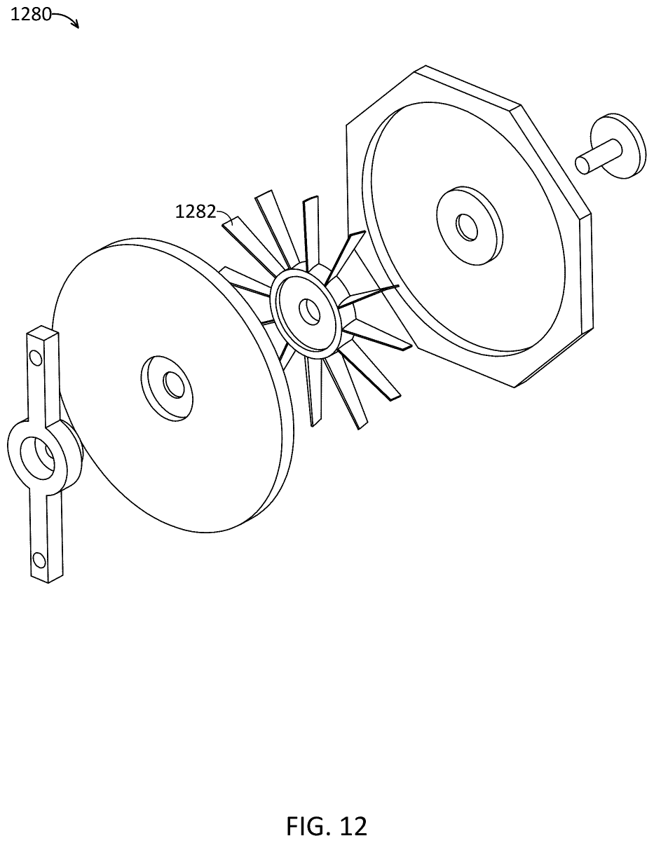

FIG. 12 is an exploded view depicting a hinge mechanism 1280 for an XR system, such as the XR system 1100 depicted in FIGS. 11A to 11C, according to some embodiments. The hinge mechanism 1280 is a fluid mechanism defining a chamber filled with a high viscosity fluid and including a rotating member 1282 disposed in the chamber and the high viscosity fluid.

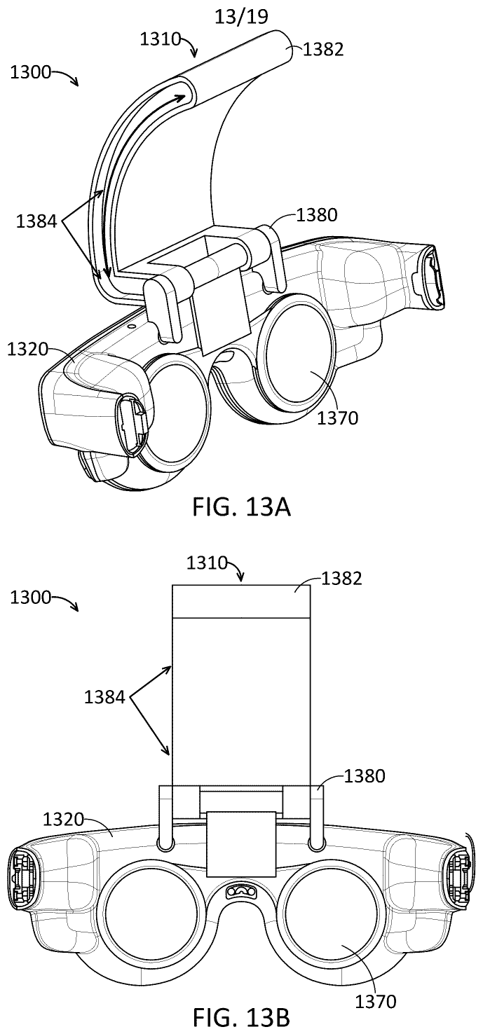

FIGS. 13A and 13B are perspective and back views depicting components of an XR system 1300, according to some embodiments. The XR system 1300 includes a frame 1310 (a stationary member 1382 of which is shown), an XR display 1320 coupled to the frame 1310 by a hinge 1380, and a vision correction component 1370 coupled to the frame 1310. The difference between the XR systems 500, 1300 is that the hinge 1380 both rotates and slides relative to the vision correction component 1370. The XR system 1300 includes a stationary member 1382 coupled to the user's head and defining a pair of grooves 1384 in opposite sides thereof. The hinge 1380 includes a pair of opposing pins (not shown) disposed respective ones of the pair of grooves 1384. The grooves 1384 define a path for the hinge 1380 and the XR display 1320 coupled thereto to translate and rotate away from the vision correction component 1370, which is coupled to the stationary member 1382 of the frame 1310.

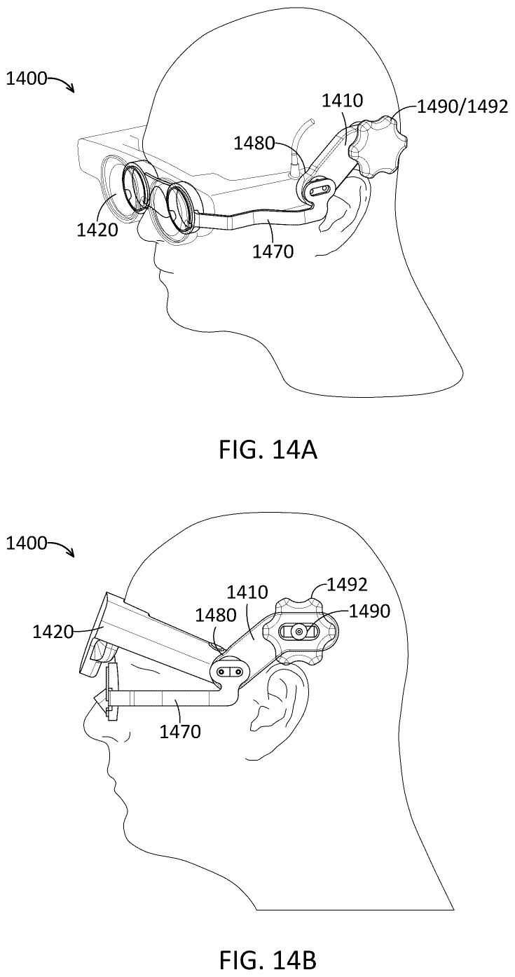

FIGS. 14A and 14B are perspective and side views depicting components of an XR system on a user's head, according to some embodiments. The XR system 1400 includes a frame 1410 (a portion of which is shown), an XR display 1420 coupled to the frame 1410 by a hinge 1480, and a vision correction component 1470 coupled to the frame 1410. Like the XR system 900 depicted in FIGS. 9A to 10, the XR system 1400 includes both a hinge 1484 rotation of the XR display 1420 relative to the vision correction component 1470, and a sliding mechanism 1490 configured to translate the XR display 1420 relative to the vision correction component. The sliding mechanism 1490 also includes a locking knob 1492 configured to prevent the XR display 1420 from translating relative to the vision correction component. The sliding mechanism 1490 adds another degree of freedom of movement of the XR display 1420 relative to the vision correction component 1470. In addition, the vision correction 1470 of the XR system 1400 is removably coupled to the frame 1410 using a pair of loops around a pair of pegs extending from the frame 1410.

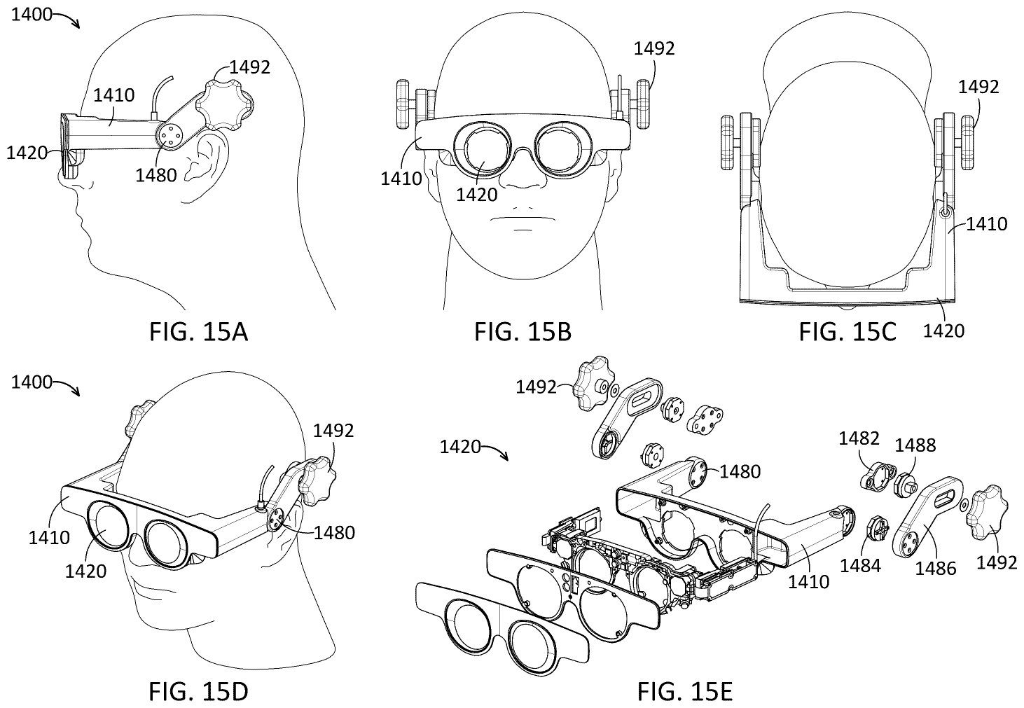

FIGS. 15A to 15D are side, front, top, and perspective views depicting components of the XR system 1400 depicted in FIGS. 14A and 14B on a user's head, according to some embodiments. The XR system 1400 includes a frame 1410 (a portion of which is shown), an XR display 1420 coupled to the frame 1410 by a hinge 1480, and a vision correction component (see FIGS. 14A to 14B) coupled to the frame 1410.

FIG. 15E is an exploded view depicting components of the XR display 1420 of the XR system 1400 depicted in FIGS. 14A and 14B, according to some embodiments. The hinge 1480 includes a bracket mount 1482, a rotating friction mechanism 1484, an arm 1486, and a sliding/rotating friction mechanism 1488 configured to interact with the locking knob 1492 to position the XR display 1420 on a user's head.

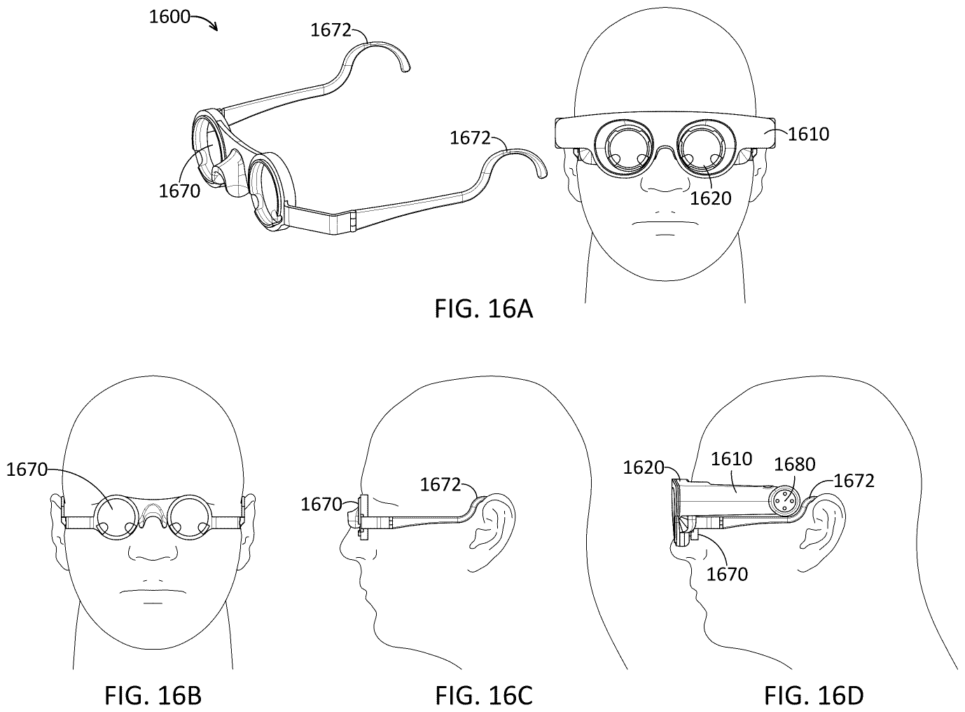

FIGS. 16A to 16D are front and side views depicting components of an XR system 1600 on a user's head, according to some embodiments. The XR system 1600 includes a frame 1610 (a portion of which is shown), an XR display 1620 coupled to the frame 1610 by a hinge 1680, and a vision correction component 1670 coupled to the head of the user. The vision correction component 1670 includes a pair of hooks 1672 configured to rest over the ears of a user to couple the vision correction component 1670 to the head of the user.

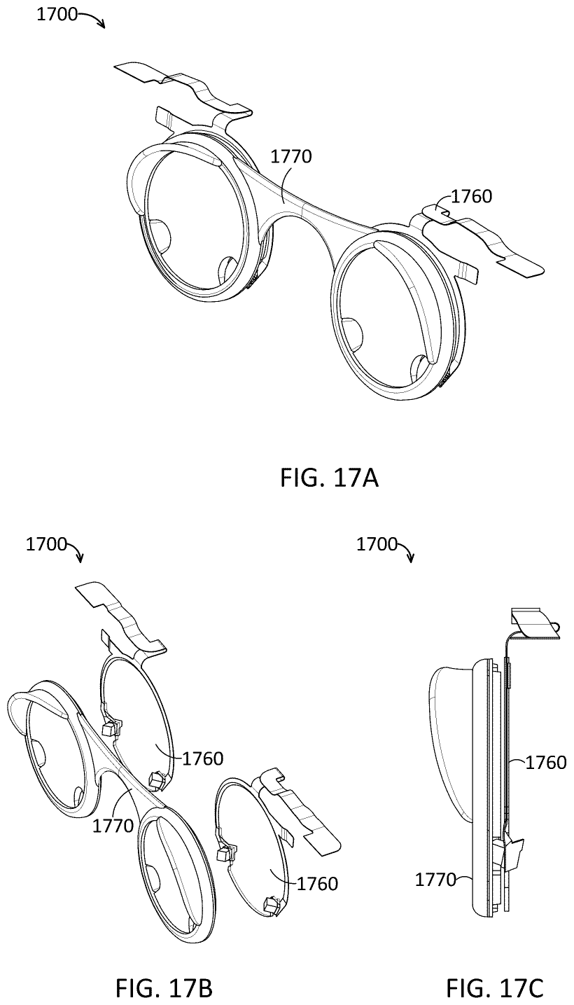

FIGS. 17A to 17C are perspective, exploded, and side views depicting components of an XR system 1700 including an eye-tracking module 1760, according to some embodiments. The XR system 1700 includes vision correction component 1770 and an eye-tracking module 1760 disposed adjacent and coupled to the vision correction component 1770. The eye-tracking module 1760 includes inward facing cameras and optionally inward facing light sources. Because the eye-tracking module 1760 is coupled to the vision correction component 1770, which is stationary relative to the user's head, eye-tracking functionality is more accurate and precise. That is, the vision correction component 1770 and eye-tracking module 1760 shown in FIGS. 17A to 17C may be utilized with the embodiments described herein such that when the XR display is moved out of the line of sight of the user, both the vision correction component 1770 and the eye-tracking module 1760 may remain in place (e.g., near the user's eyes, in the line of sight of the user, etc.), as both the vision correction component 1770 and the eye-tracking module 1760 are movable (e.g., rotatable, translatable, etc.) relative to the XR display (e.g., the eye-tracking module 1760 is coupled or attached to the vision correction component 1770 in a fixed or at least temporarily fixed manner).

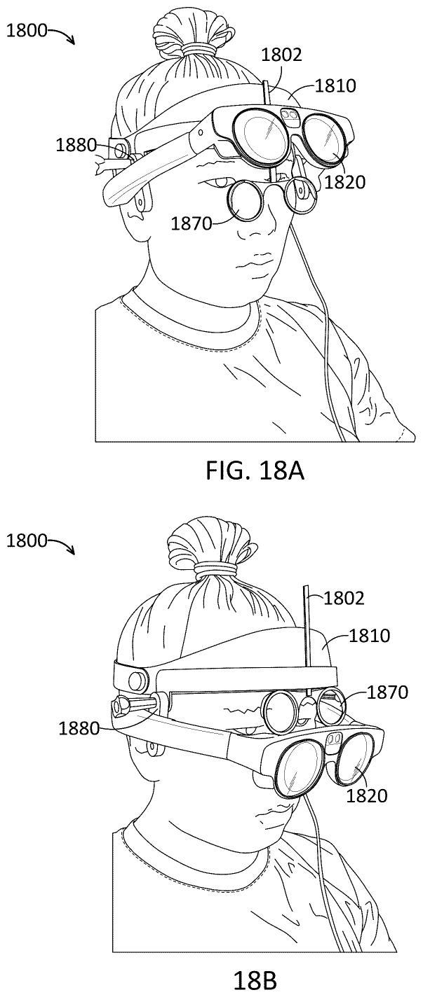

FIGS. 18A and 18B are perspective views depicting components of an XR system 1800 in two different configurations on a user's head, according to some embodiments. The XR system 1800 includes an XR display 1820 and a vision correction component 1870, both movably coupled to a frame 1810 by a hinge 1880. The XR system 1800 also includes a mechanical linkage 1802 configured to move the second vision correction component 1870 into a line of sight of a user when the XR display 1820 is moved out of the line of sight of the user (FIG. 18A), and move the second vision correction component 1870 out of the line of sight of the user when the XR display 1820 is moved into the line of sight of the user (FIG. 18B). The mechanical linkage 1802 may be a gearing system, such as a reciprocal gearing system. With such a gearing system, when the XR display 1820 is moved up out of the line of sight of the user, the gearing system moves the second vision correction component 1870 down into the line of sight of the user (FIG. 18A). Similarly, when the XR display 1820 is moved into the line of sight of the user, the gearing system moves the second vision correction component 1870 up out of the line of sight of the user (FIG. 18B).

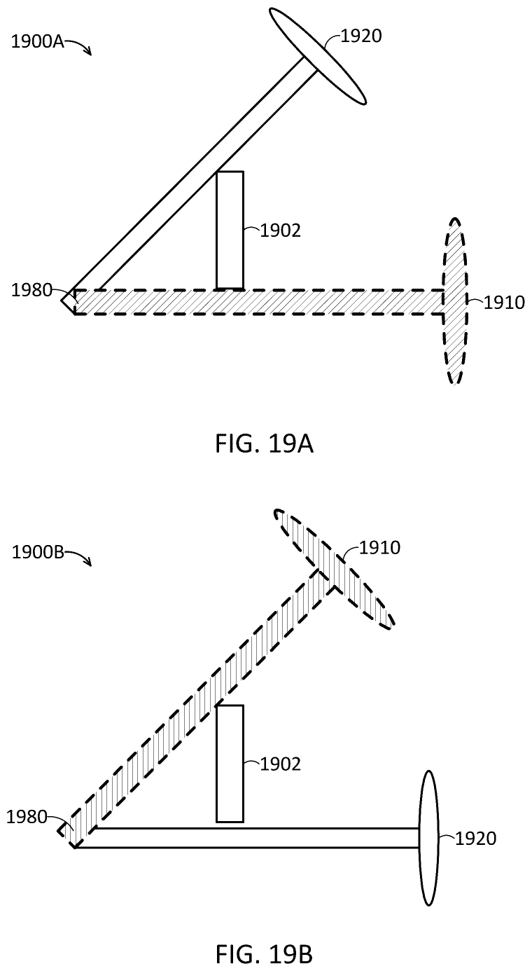

FIGS. 19A and 19B schematically depict components of an XR system 1900 in two different configurations, according to some embodiments. The XR system 1900 includes an XR display 1920 and a vision correction component 1970, both movably coupled to a frame (not shown) by a hinge 1980. The XR system 1900 also includes a mechanical linkage 1902 configured to move the second vision correction component 1970 into a line of sight of a user when the XR display 1920 is moved out of the line of sight of the user (FIG. 19A), and move the second vision correction component 1970 out of the line of sight of the user when the XR display 1920 is moved into the line of sight of the user (FIG. 19B). The mechanical linkage 1902 may be a gearing system, such as a reciprocal gearing system. With such a gearing system, when the XR display 1920 is moved up out of the line of sight of the user, the gearing system moves the second vision correction component 1970 down into the line of sight of the user (FIG. 19A). Similarly, when the XR display 1920 is moved into the line of sight of the user, the gearing system moves the second vision correction component 1970 up out of the line of sight of the user (FIG. 19B).

Certain aspects, advantages and features of the disclosure have been described herein. It is to be understood that not necessarily all such advantages may be achieved in accordance with any particular embodiment of the disclosure. Thus, the disclosure may be embodied or carried out in a manner that achieves or optimizes one advantage or group of advantages as taught herein without necessarily achieving other advantages as may be taught or suggested herein.

Embodiments have been described in connection with the accompanying drawings. However, it should be understood that the figures are not drawn to scale. Distances, angles, etc. are merely illustrative and do not necessarily bear an exact relationship to actual dimensions and layout of the devices illustrated. In addition, the foregoing embodiments have been described at a level of detail to allow one of ordinary skill in the art to make and use the devices, systems, methods, and the like described herein. A wide variety of variation is possible. Components, elements, and/or steps may be altered, added, removed, or rearranged.

The devices and methods described herein can advantageously be at least partially implemented using, for example, computer software, hardware, firmware, or any combination of software, hardware, and firmware. Software modules can include computer executable code, stored in a computer's memory, for performing the functions described herein. In some embodiments, computer-executable code is executed by one or more general purpose computers. However, a skilled artisan will appreciate, in light of this disclosure, that any module that can be implemented using software to be executed on a general-purpose computer can also be implemented using a different combination of hardware, software, or firmware. For example, such a module can be implemented completely in hardware using a combination of integrated circuits. Alternatively or additionally, such a module can be implemented completely or partially using specialized computers designed to perform the particular functions described herein rather than by general purpose computers. In addition, where methods are described that are, or could be, at least in part carried out by computer software, it should be understood that such methods can be provided on non-transitory computer-readable media that, when read by a computer or other processing device, cause it to carry out the method.

While certain embodiments have been explicitly described, other embodiments will become apparent to those of ordinary skill in the art based on this disclosure.

The various processors and other electronic components described herein are suitable for use with any optical system for projecting light. The various processors and other electronic components described herein are also suitable for use with any audio system for receiving voice commands.

Various exemplary embodiments of the disclosure are described herein. Reference is made to these examples in a non-limiting sense. They are provided to illustrate more broadly applicable aspects of the disclosure. Various changes may be made to the disclosure described and equivalents may be substituted without departing from the true spirit and scope of the disclosure. In addition, many modifications may be made to adapt a particular situation, material, composition of matter, process, process act(s) or step(s) to the objective(s), spirit or scope of the present disclosure. Further, as will be appreciated by those with skill in the art, each of the individual variations described and illustrated herein has discrete components and features which may be readily separated from or combined with the features of any of the other several embodiments without departing from the scope or spirit of the present disclosure. All such modifications are intended to be within the scope of claims associated with this disclosure.

The disclosure includes methods that may be performed using the subject devices. The methods may include the act of providing such a suitable device. Such provision may be performed by the end user. In other words, the “providing” act merely requires the end user obtain, access, approach, position, set-up, activate, power-up or otherwise act to provide the requisite device in the subject method. Methods recited herein may be carried out in any order of the recited events which is logically possible, as well as in the recited order of events.

Exemplary aspects of the disclosure, together with details regarding material selection and manufacture have been set forth above. As for other details of the present disclosure, these may be appreciated in connection with the above-referenced patents and publications as well as generally known or appreciated by those with skill in the art. The same may hold true with respect to method-based aspects of the disclosure in terms of additional acts as commonly or logically employed.

In addition, though the disclosure has been described in reference to several examples optionally incorporating various features, the disclosure is not to be limited to that which is described or indicated as contemplated with respect to each variation of the disclosure. Various changes may be made to the disclosure described and equivalents (whether recited herein or not included for the sake of some brevity) may be substituted without departing from the true spirit and scope of the disclosure. In addition, where a range of values is provided, it is understood that every intervening value, between the upper and lower limit of that range and any other stated or intervening value in that stated range, is encompassed within the disclosure.

Also, it is contemplated that any optional feature of the variations described may be set forth and claimed independently, or in combination with any one or more of the features described herein. Reference to a singular item, includes the possibility that there are plural of the same items present. More specifically, as used herein and in claims associated hereto, the singular forms “a,” “an,” “said,” and “the” include plural referents unless the specifically stated otherwise. In other words, use of the articles allow for “at least one” of the subject item in the description above as well as claims associated with this disclosure. It is further noted that such claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in claims associated with this disclosure shall allow for the inclusion of any additional element—irrespective of whether a given number of elements are enumerated in such claims, or the addition of a feature could be regarded as transforming the nature of an element set forth in such claims. Except as specifically defined herein, all technical and scientific terms used herein are to be given as broad a commonly understood meaning as possible while maintaining claim validity.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are, accordingly, to be regarded in an illustrative rather than restrictive sense.

The breadth of the present invention is not to be limited to the examples provided and/or the subject specification, but rather only by the scope of claim language associated with this disclosure.

1. An extended reality (XR) system, comprising:
an XR display configured to be movably disposed in a line of sight of a user, the XR display having a first vision correction component;
a second vision correction component configured to be movably disposed in the line of sight of the user when the XR display is not disposed in the line of sight of the user; and
a mechanical linkage configured to
move the second vision correction component into the line of sight of the user when the XR display is moved out of the line of sight of the user, and
move the second vision correction component out of the line of sight of the user when the XR display is moved into the line of sight of the user.

2. The system of claim 1, further comprising an eye-tracking system coupled to the vision correction component.

3. The system of claim 2, wherein the XR system is configured such that when the XR display is moved out of the light of sight of the user, the eye-tracking system remains coupled to the vision correction component.

4. The system of claim 2, wherein the XR system is configured such that when the XR display is moved out of the light of sight of the user, the eye-tracking system and the vision correction component remain in the line of sight of the user.

5. The system of claim 2, wherein the eye-tracking component comprises a sensor.

6. The system of claim 5, wherein the sensor is a camera.

7. The system of claim 6, wherein the eye-tracking component further comprises an inward facing light source.

8. The system of claim 1, wherein the first vision correction component comprises a first lens coupled to the XR display.

9. The system of claim 8, wherein the first lens is magnetically coupled to the XR display.

10. The system of claim 1, wherein the second vision correction component comprises a second lens.

11. The system of claim 1, wherein the mechanical linkage comprises a gearing system.

12. The system of claim 1, wherein the XR display is configured to move up and down relative to the user's head.

13. The system of claim 1, wherein the second vision correction component is configured to move up and down relative to the user's head.

14. The system of claim 1, wherein the mechanical linkage is configured to move the second vision correction component down into the line of sight of the user when the XR display is moved up out of the line of sight of the user.

15. The system of claim 1, wherein the mechanical linkage is configured to move the second vision correction component up out of the line of sight of the user when the XR display is moved down into the line of sight of the user.

16. An extended reality (XR) system, comprising:
an XR display configured to be movably disposed in a line of sight of a user;
a vision correction component configured to be disposed in the line of sight of the user; and
a displacement mechanism configured to
guide the XR display out of the line of sight of the user while the vision correction component remains in the line of sight of the user, and
limit relative positions of the XR display and the vision correction component.

17. The system of claim 16, wherein the displacement mechanism is also a registration mechanism.

18. The system of claim 16, further comprising an eye-tracking system coupled to the vision correction component.

19. The system of claim 18, wherein the XR system is configured such that when the XR display is moved out of the light of sight of the user, the eye-tracking system remains coupled to the vision correction component.

20. The system of claim 18, wherein the XR system is configured such that when the XR display is moved out of the light of sight of the user, the eye-tracking system and the vision correction component remain in the line of sight of the user.

21.-41. (canceled)
